(19) United States
(12) Patent Application Publication
(10) Pub. No.: US 2004/0231686 A1
(43) Pub. Date: Nov. 25, 2004

(54) Nail polish bottle holder

(76) Inventors: Vivianne Florene Watson, Lakeland, FL (US); Ronald Charles Howe, Lakeland, FL (US)

Correspondence Address: Vivianne F. Watson, 6012 Cason Way, Lakeland, FL, 33813, US

(21) Appl. No.: 10/441,561

(22) Filed: May 20, 2003

(51) Int. Cl. A45D 29/18; B26B 13/22

(52) U.S. Cl. 132/73.5

(57) ABSTRACT

Disclosed is an improved nail polish bottle holder which holds the bottle stably at a convenient dispensing angle.

### FIELD OF THE INVENTION

The invention relates to an improved cosmetics bottle holder which is capable of holding and storing different sizes and shapes of containers. More specifically, the invention relates to an improved nail polish bottle holder which holds the bottle stably at a convenient dispensing angle.

### BACKGROUND OF THE INVENTION

Users of cosmetics often have a number of bottles of various sizes and shapes containing cosmetic nail polish. When in use, containers used for holding and storing nail polish are often placed on a counter top or support surface while the container or bottle remains open. Nail polish bottles come equipped with a lid or cap that incorporates a brush or applicator. As a result, the bottle remains open while the brush or applicator is being used to apply the nail polish. If the bottle is accidentally knocked over, the nail polish will spill out, resulting in a mess that is often hard to clean. As the act of painting one's finger nails or toe nails requires frequent re-application of nail polish, the repeated insertion and removal of the applicator or brush itself often causes the bottle to be knocked over. Consequently frequent spills occur. The chance of spills increases dramatically when the product in the nail polish bottle, through prior consumption of the product, reaches low levels within the bottle or container which causes the individual to insert the applicator or brush deeper inside the container to reach the product.

U.S. Pat. No. 5,881,734 discloses a complex nail polish bottle holder having a receptacle for the bottle and a strap that is affixed to the wrist of the person who is applying the nail polish; however, the receptacle seems to only fit a certain size bottle and the strap affixed to one's wrist does not provide flexibility. It would be very easy to accidentally turn or twist your wrist and spill the contents of the bottle. The bottle receptacle does not have too much room for the bottle; the bottle could tip and spill the contents.

U.S. Pat. No. 5,743,406 discloses a plan with VELCRO straps on a slopping surface inside the pan.

Several other types of nail polish bottle holders have also been proposed. For example, in U.S. Pat. Nos. 5,909,811, D441,914 and 5,913,312, the bottle holders described do not provide the same flexibility or ease of use as the invention described herein. To use the nail polish bottle holders previously documented consumers must perform awkward and uncomfortable tasks and encounter high potential of spillage of the bottles' contents during use.

Therefore, there is a need in the art for a device for the stable holding of cosmetic nail polish bottles of various sizes which enhances access to the product contained in the bottle while preventing the bottles or containers from spilling during use. This and other embodiments of the present invention will become apparent to those of skill in the art upon review of this patent specification, claims and drawings.

### SUMMARY OF THE INVENTION

The nail polish bottle holder of the invention provides a steady platform for the dispensing out of cosmetic nail polish bottles of various sizes shapes and types useful quantities of nail polish. More specifically, the cosmetics holder of the invention enables the user to hold nail polish bottles in a stable environment at an angle which provides ease of access while facilitating the drip-less dispensing of nail polish from the bottle or container onto a nail polish brush or applicator.

The nail polish bottle holder of the invention is a three dimensional rectangle, without an upper surface but which utilizes its unique angled interior surface to act as a stable platform and hold the nail polish bottle at a defined angle which provides the user enhanced access to the contents of the nail polish bottle.

### DESCRIPTION OF THE DRAWINGS

FIG. 1 is a plan view of nail polish bottle holder 10.

FIG. 2 is a top view of nail polish bottle holder 10.

FIG. 3 is a side view of nail polish bottle holder 10.

FIG. 4 is a longitudinal cross section of the nail polish bottle holder 10 showing a view of the interior area 14 with angled surfaces 22.

FIG. 5 is a side view of nail polish bottle holder 10 with nail polish bottle 20.

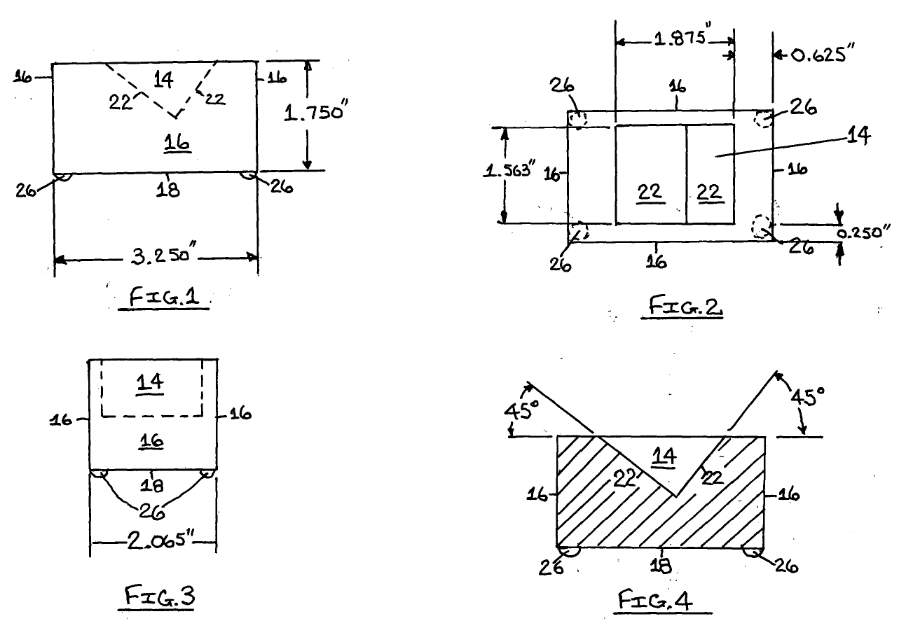

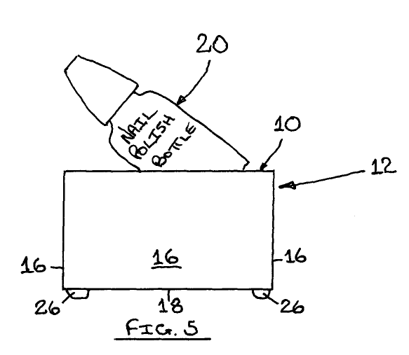

### DETAILED DESCRIPTION OF THE INVENTION

The nail polish bottle holder of the invention includes a housing made of a suitable rigid material, the housing defines an interior which contains angled surfaces extending from a top side of the housing to a bottom part of the housing thereby forming a stable, inclined cradle for the nail polish bottle is formed.

Referring now to the figures, nail polish bottle holder 10 of the invention includes housing 12, which defines interior area 14, and has sides 16 and bottom 18. Inside interior area 14, are interior angled surfaces 22 which extend from a top of at least one side 16 to a point on bottom 18. The angled surfaces 22 and the interior side of side 16 define bottle cradle area 14 which can accommodate bottle 20. Optionally, bottom 18 of holder 10 may include a non-skid means 26 attached thereto. Suitable examples on non-skid means 26 include rubber or plastic button-like feet, and the like.

Holder 10 may be manufactured out of any suitable material. Non-limiting examples of suitable materials include wood, plastic, glass, resin, metal, ceramics, rock (i.e. marble or onyx) and fiberglass.

Holder 10 may be made in any suitable shape and size and may be assembled by means known in the art. In one embodiment, and referring for example to FIG. 5, holder 10 may be rectangular in shape and sized to accommodate a single bottle 20. In one embodiment, housing 12 is rectangular in shape having two longer sides between about 3 inches to about 3.5 inches long and shorter sides between about 1.5 inches to about 2.5 inches wide. In a preferred embodiment, housing 12 is rectangular in shape having two longer sides between about 3.25 inches to about 3.30 inches long and shorter sides between about 2.0 inches to about 2.2 inches wide.

In another embodiment, it is understood that more than one holder 10 may be combined or attached together. The holders 10 may be attached together in shapes such as rectangular or other polygons having from 3 to 10 sides, or circular shapes including ovals. It is also understood that if the compartments are attached together they may also be attached to or used in association with a means to spin or rotate the combined holders.

In a preferred embodiment, housing 12 is rectangular in shape and each angled surfaces 22 are positioned at approximately a 45 degree angle from top of each of a shorter side 16 of housing 12 meeting in the middle of the interior side of bottom surface 18 at approximately a 90 degrees angle.

In a stylized, decorative embodiment, the Holder 10, could simply consist of the bottom 18 supporting in the freestanding interior area 14 at the base of the 90 degree angle described by the connection of the angled surfaces 22. Longitudinal sides 16 of the holder 10 on each side of the interior area 14 could be fashioned into right angle triangles to act as retaining sides to this embodiment.

In a mobile embodiment of the Holder 10, the non-skid bottoms 26 could consist of two Velcro strips. One Velcro strip could be attached to the dashboard of an automobile, and the second Velcro strip could be attached to the bottom of Holder 10. When pressed together in the commonly accepted Velcro application, the Velcro strips would fix the Holder 10 securely to an automobile's dashboard.

We claim:

1. A nail polish bottle holder comprising a housing having sides and a bottom, where the sides and bottom define an interior area, where in the interior area there is at least one angled surface extending from a top of one of the sides to the bottom where the angled surface defines a cradle area.

2. The nail polish bottle holder of claim 1 where the housing is a rectangular shape having a first short side and a second short side.

3. The nail polish bottle holder of claim 2 where there are two angled surfaces defining the cradle area.

4. The nail polish bottle holder of claim 3 where one angled surface extends from the top of the first short side to the bottom and where the other angled surface extends from the top of the second short side to the bottom.

5. The nail polish bottle holder of claim 4 where the angled surfaces meet in a middle area of the bottom surface at approximately a 90 degrees angle.

6. The nail polish bottle holder of claim 2 where the rectangular shape is about 3.0 to about 3.5 inches by about 1.5 to about 2.5 inches.

7. The nail polish bottle holder of claim 1 where the bottom further comprising non-skid means.

8. A nail polish bottle holder comprising a rectangular housing having sides and a bottom, where the sides and bottom define an interior area, where in the interior area there are two angled surfaces, each extending from a top of one of the sides to the bottom, where the two angled surfaces meet a middle area of the bottom at about a 90 degree angle and define a cradle area.

9. The nail polish bottle holder of claim 8 where the rectangular shape is about 3.0 to about 3.5 inches by about 1.5 to about 2.5 inches.

10. The nail polish bottle holder of claim 8 where the bottom further comprising non-skid means.

11. A multiple nail polish bottle holder comprising more than one of the nail polish bottle holders described by claim 1.

12. The multiple nail polish bottle holder of claim 8 further comprising a means to spin the holder.
